(19) United States
(12) Patent Application Publication
(10) Pub. No.: US 2007/0014651 A1
(43) Pub. Date: Jan. 18, 2007

(54) Post and sliding washer for holding scrap books together

(76) Inventor: Stephen T. Powell, Austin, TX (US)

Correspondence Address: FORTKORT GRETHER & KELTON LLP, 9442 N. Capital of Texas Hwy., Arboretum Plaza One, Suite 500, AUSTIN, TX, 78759, US

(21) Appl. No.: 11/183,319

(22) Filed: Jul. 15, 2005

(51) Int. Cl. F16B 33/00

(52) U.S. Cl. 411/378

(57) ABSTRACT

Provided is a post with a head that is pushed through the binder of a scrap book. The post has a number of angular protrusions, each of which together define one of more channels which line up with each other. On the head side of each ring or angular protrusions is one or more fixation protrusions. A corresponding sliding washer is constructed such that there is a hole in the middle and one or more tabs that extend into the hole. The sliding washer slides over the post when the tabs line up with the channels and secures the binding when rotated such that the tabs and channels do not line up. Further, the fixation protrusions in the angular protrusions fit into corresponding notches in the sliding washer such that the sliding washer will not rotate once secured unless pressure is applied to disengage the fixation protrusions from the notches.

### CROSS-REFERENCE TO RELATED APPLICATIONS

The present application is related to and claims the benefit of the filing date of the following provisional application with a common inventor, which is hereby incorporated by reference:
U.S. Provisional Patent Application Ser. No. 60/558,134 (Attorney Docket Number POWL001USP), filed Jul. 15, 2004, titled “Post and Sliding Washer for Holding Scrap Books Together.”

### FIELD OF THE INVENTION

This invention pertains generally to a system for securing materials together and, more specifically to a post and washer that lock together after the post is pushed through holes in the materials.

### BACKGROUND OF THE INVENTION

The creation and maintenance of scrap books has become a popular pastime. Since a scrap book typically grows over time, one particular issue that arises is the ease that the book can be assembled, taken apart and then reassembled with the addition of new materials. People use several different techniques to hold the books together, e.g. clips that snap together or posts and matching nuts. Many of these current fasteners are either designed for single use or, if a standard post and nut configuration is used, expensive and difficult to use.

Of course, there is always a need for simple, inexpensive, means for securing materials together such that the materials can be secured to each other, taken apart and resecured if necessary.

### BRIEF SUMMARY OF THE INVENTION

The invention provides such a system of posts and corresponding nuts, or washers, such that a scrap book can be bound together, unbound and rebound with additional materials. These and other advantages of the invention, as well as additional inventive features, will be apparent from the description of the invention provided herein.

Provided is a post with a head and angular protrusions that is pushed through the binder of a scrap book. The angular protrusions are aligned in concentric evenly spaced rings such that channels are created down the post. On the head side of at least one angular protrusion in each concentric ring is one or more fixation protrusions. A corresponding sliding washer is constructed such that there is a hole in the middle and one or more tabs that extend into the hole. A particular sliding washer is constructed to fit a particular post such that the tabs correspond to the channels in the angular protrusions. The sliding washer slides over the post when the tabs line up with the channels and secures the binding when the washer is rotated such that the tabs and channels do not line up and the fixation protrusions fit into corresponding notches, or indentations, in the sliding washer. In this manner, the sliding washer does not rotate once secured unless rotational pressure is applied to disengage the protrusions from the indnetations.

In the alternative, the fixation protrusions are on the washer and the indentations are in the angular protrusions. In some embodiments, the fixation protrusions are dimples and the notches are matching depressions. In another embodiment, the protrusions are triangular with matching notches.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE DRAWINGS

FIG. 1 is an exploded of an exemplary scrap book showing the relative position of the post of the claimed subject matter.

FIG. 2 is a more detail view of the post of FIG. 1.

FIG. 3 is another view of the post of FIGS. 1 and 2.

FIG. 4 is a close up of the post of FIGS. 1, 2 and 3, showing fixation protrusions affixed to the angular protrusions.

FIG. 5 is a top view of an exemplary sliding washer according to the claimed subject matter.

FIG. 6 is a bottom view of an alternative embodiment of the sliding washer of the claimed subject matter.

FIG. 7 is a view of another embodiment of the sliding washer according to the claimed subject matter.

### DETAILED DESCRIPTION OF THE INVENTION

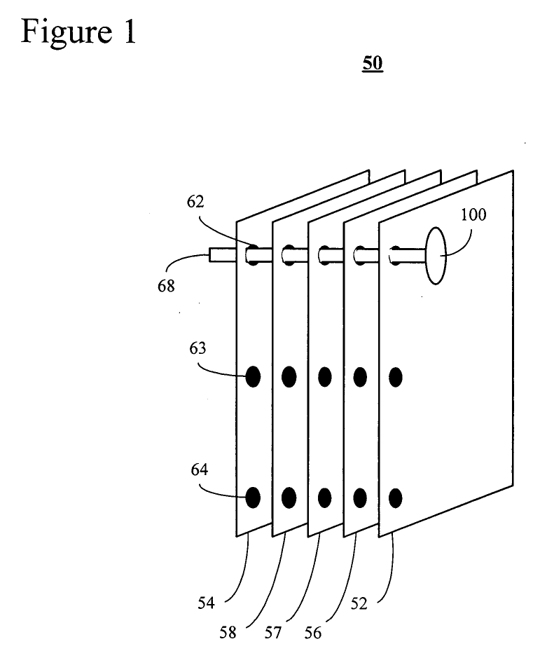

FIG. 1 is an exploded view of an exemplary scrap book 50 showing the relative position of a post 100 of the claimed subject matter. Scrap book 50 includes a front cover 52 and a back cover 54. In between covers 52 and 54 are a number of pages 56-58. The specific number of pages is not relevant. Those with skill in the scrap booking arts should appreciate that the number of page varies according to the quantity of information stored in scrap book 50.

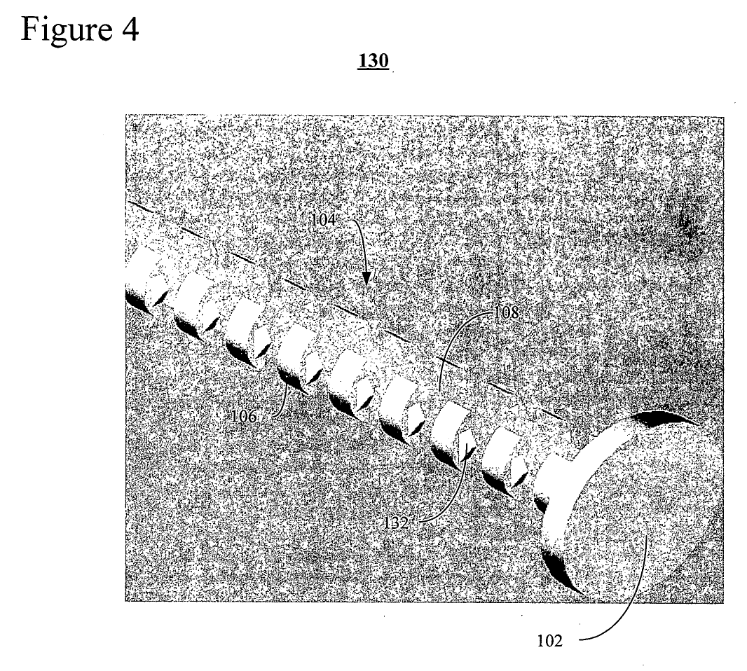

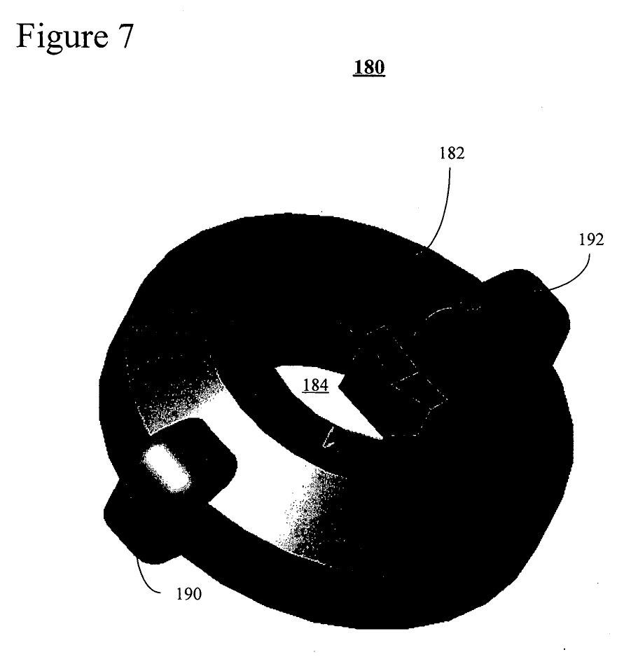

Each of covers 52 and 54 and pages 56-58 include a number of holes 62-64, although only the holes in back cover 54 are labeled. Post 100 is inserted through corresponding holes in covers 52 and 54 and pages 56-58 to hold covers 52 and 54 and pages 56-58 in a fixed position relative to each other. As explained below in conjunction with FIGS. 4-7, a washer, such as washer 180 (see FIG. 7), is placed on a distal end 68 of post 100 to align covers 52 and 54 and pages 56-58 from prevent them from separating.

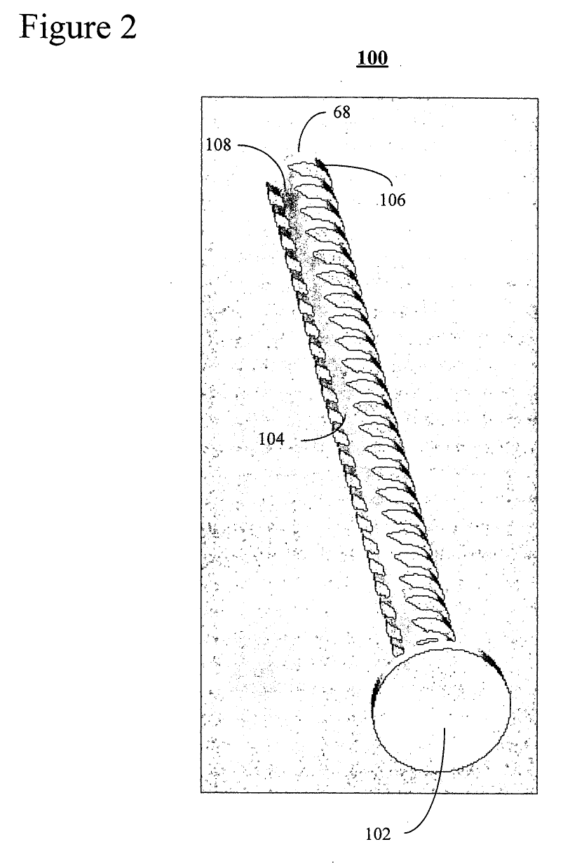

FIG. 2 is one view of post 100 (FIG. 1) according to the claimed subject matter in more detail. Post 100 includes a head 102, a post rod 104, angular protrusions 106 (only one of which is marked) and a channel 108 that extends through angular protrusions. In the following description, the term “successive angular protrusions” implies that the referenced protrusions 106 are above or below each other on rod 104. In this view, angular protrusions 106 extend partially around post rod 104 and extend from post rod 104. In other words, sets of angular protrusions 106 describe evenly spaced circles that are interrupted at channels 108. In an alternative embodiment, angular protrusions 106 define ovals rather than circles.

When employed to secure covers 52 and 54 (FIG. 1) and pages 56-58 (FIG. 1) in scrap book 50 (FIG. 1), post rod 104, and the attached angular protrusions 106 are inserted through holes in scrap book's 50 front cover 52, back cover 54 and secures pages 56-58 between covers 52 and 54. The side of head 102 that faces rod 104 butts up against one of covers 52 and 54, typically front cover 52, thus preventing rod 104 from passing completely through scrap book 50.

In other words, post 100 is pushed through holes in a binder (not shown) or a scrap book, note book or any apparatus that uses a binder in which pages are held in place between two halves of a binder by extending some device through holes in the binder haves and holes in the paper. Head 102 prevents post 100 from pushing completely through the holes in which it is placed.

It should be understood that the claimed fastener is applicable to many types of fastening task other than scrap books and binders. Although described only in relation to a scrap book, the claimed subject matter may be applied to hold any material in which holes can be drilled, molded, punched, and so on.

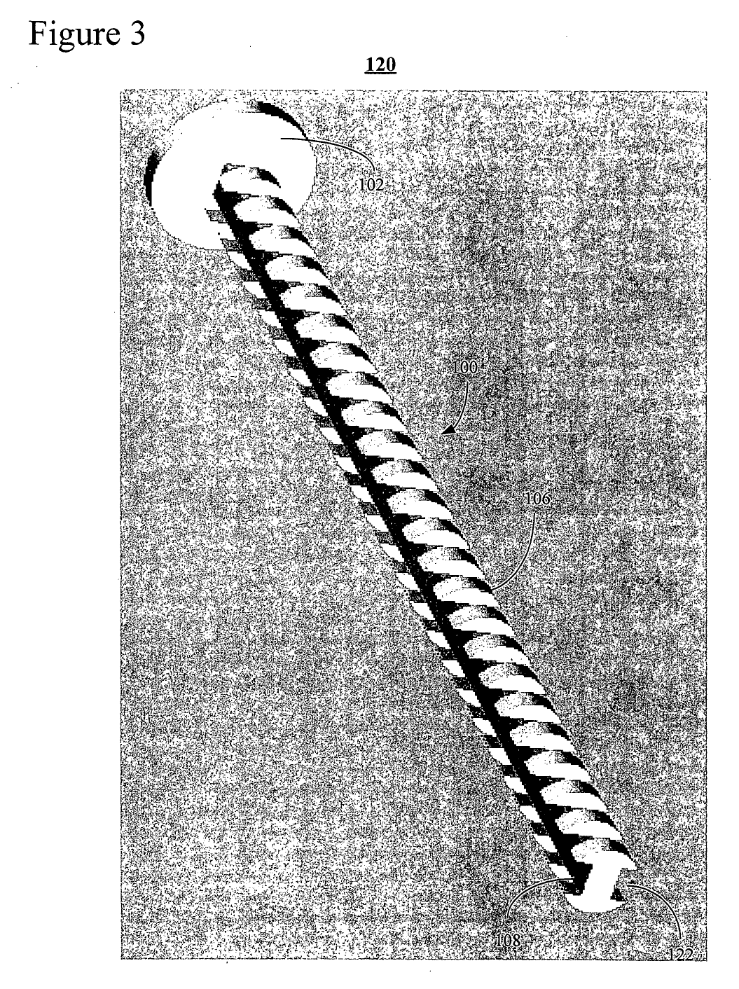

FIG. 3 is another view 120 from a second angle of post 100 of FIG. 1. Elements 102, 104, 106 and 108 are the same as in FIG. 2. In this view a second channel 122 is also visible. Channel 122 is positioned opposite channel 108 on post 108. In an alternative embodiment channel 122 could be positioned at some position other than one hundred eighty degrees (180°) from channel 108. Further, an alternative embodiment may only include one channel. Angular protrusions 106 and channels 108 and 122 are explained in more detail below in conjunction with FIGS. 3-7.

FIG. 4 is a close up of post 100 of FIGS. 1 and 2, showing fixation protrusions 132 on some angular protrusions 106 (FIGS. 1 and 2). It should be noted that fixation protrusions 132 may be on one or more angular protrusions 106 in each concentric circle of angular protrusions 106. Head 102 (FIGS. 1 and 2) and channel 106 (FIGS. 1 and 2) are also illustrated. Fixation protrusions 132 are positioned on the side of each circle 106 facing head 102. Although illustrated as a triangular shape, fixation protrusions 132 may be many possible configurations, such as, but not limited to, spherical bumps.

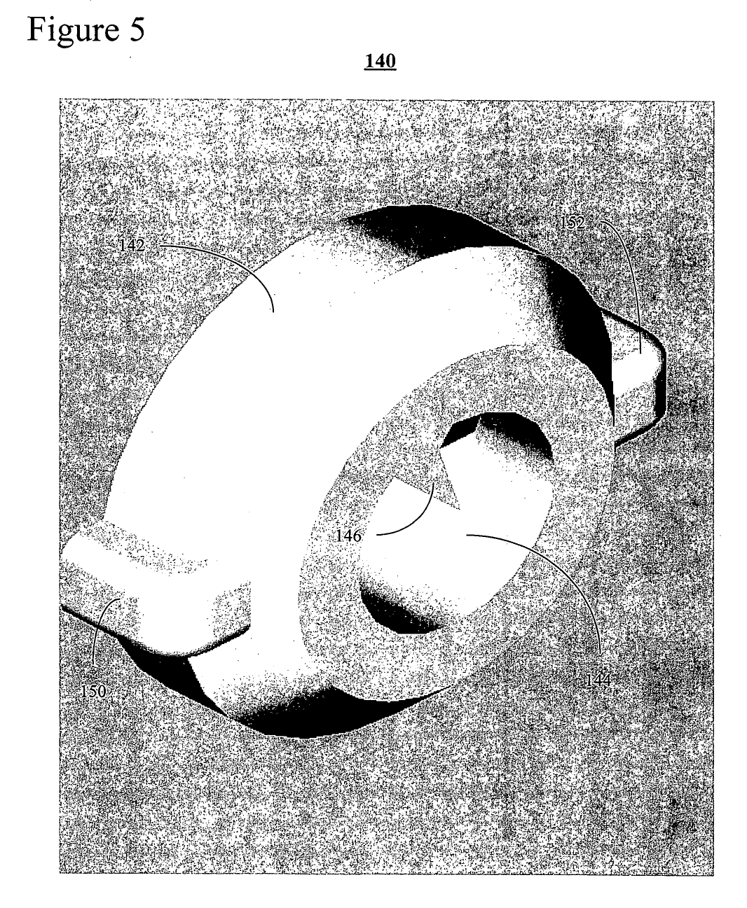

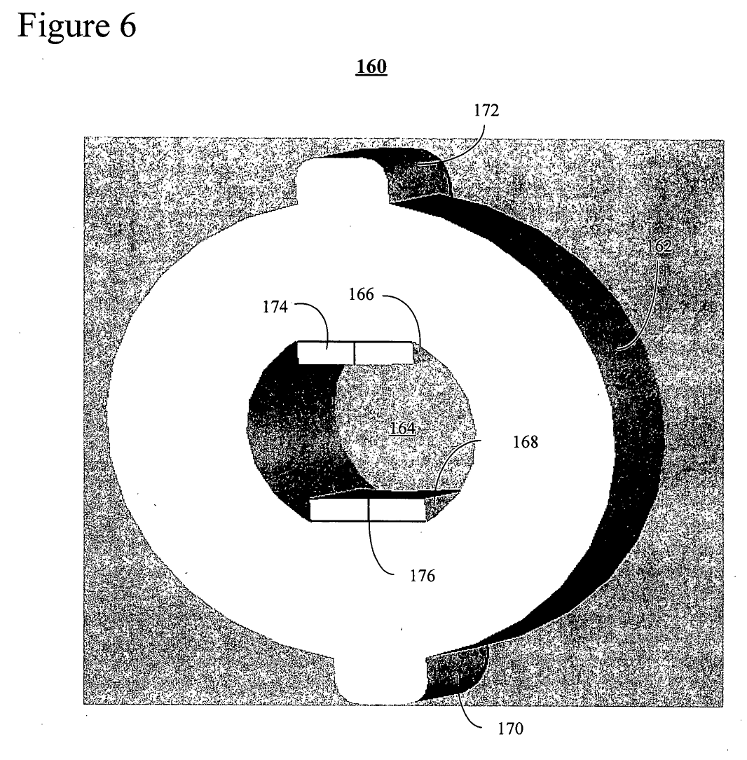

FIG. 5 is a top view 140 of an exemplary sliding washer 142 according to the claimed subject matter. Top view 140 is a view of a top surface of washer 142. Washer 142 includes a hole 144, a tab 146, a notch 146 and extenders 150 and 152. Washer 142 slides over post 100 (FIGS. 1-3) at distal end 68 (FIGS. 1 and 2) with the top surface facing away from head 102 (FIGS. 1-3). It should be noted that washer 142 will only slide over post 102 when tab 146 lines up with either channel 108 (FIGS. 1-3) or channel 122 (FIG. 2). Tab 146 illustrates only one possible configuration of tab 146. Other possible configurations are shown below in conjunction with FIGS. 5 and 6.

Extenders 150 and 152 facilitate the turning of washer 142 when washer 142 is slid over post 100. As explained below in conjunction with FIGS. 6 and 7, one aspect of securing washer 142 in a locked position on post 100 is turning washer 142 so that tab 146 is no longer lined up with either channel 108 or 122.

FIG. 6 is a bottom view 160 of a sliding washer 162 which is an alternative embodiment of sliding washer 142 of FIG. 5. A hole 164 corresponds to hole 144 (FIG. 5) and extenders 170 and 172 correspond to extenders 150 and 152 (FIG. 5). Rather than a single tab 146 (FIG. 5), washer 162 includes a tab 168 and a tab 168. Tabs 166 and 168 line up with channels 108 (FIGS. 1-3) and 122 (FIGS. 2 and 3) in order for washer 162 to slide onto post 100 (FIGS. 1-3). As explained above in conjunction with FIG. 3, channels 108 and 122 do not necessarily have to be positioned directly opposite each other. In a similar fashion, tabs 166 and 168 do not need to be positioned directly opposite each other with respect to hole 164. However, in order for washer 162 to slide upon post 104, tabs 166 and 168 are oriented in the same position with respect to each other as channels 108 and 122. Tabs 166 and 168 include indentations 174 and 176 respectively. Indentations are illustrated and explained in more detail below in conjunction with FIG. 7.

FIG. 7 is a view 180 of a sliding washer 182 according to the claimed subject matter. A tab 186 does not extend all the way through a hole 184, which enables washer 182 to rotate around post 100 (FIGS. 1-3) as long as tab 186 is positioned in between two successive angular protrusions 106 (FIGS. 2 and 3). When washer 182 is rotated so that tabs 186 line up with channels 108, washer 182 slides down post 100. Once a scrap book 50 has been compressed by pushing washer 182 onto post 100 and washer 182 is rotated so that tab 186 no longer line up with channel 108 or 122, then one of fixation protrusions 132 fit into notch 188 in tab 186, thus locking washer 182 in position. To release washer 182, washer 182 is pushed towards head 102 until one of fixation protrusions 132 disengage from notch 188, washer 142 is rotated until tab 186 lines up with channel 108 or 122 and washer 182 is slid off post 100. It should be noted that although FIG. 7 only shows one tab 186 and notch 188 there may be multiple tabs and notched depending upon the configuration of post 100.

In an alternative embodiment, a scrap book is secured on a post between two washers rather than between a washer and a cap.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A system for securing materials together, comprising:
a post, comprising:
a head affixed to one end of the post;
angular protrusions extending from the post and configured in multiple evenly spaced rows such that one or more channels are formed along the post; and
fixation protrusions extending from at least one of the angular protrusions in each row;
a washer, comprising:
a washer body;
a hole through the washer body;
one or more tabs positioned within the hole and affixed to the washer body; and
an indentation within the one or more tabs; and
wherein, a distal end of the post slides holes through two or more materials to be secured together and through the washer body when the tabs are aligned with the channels;
wherein, the washer is secured when the washer is rotated such that the fixation protrusions fit into corresponding indentations and the tabs no longer line up with the channels; and
wherein compression secures the fixation protrusions into the respective indentations.
